(19) United States
(12) Patent Application Publication
(10) Pub. No.: US 2026/0348563 A1
(43) Pub. Date: Nov. 5, 2026

(54) A SYSTEM COMPRISING A LIGHTING DEVICE

(71) Applicant: SIGNIFY HOLDINGS B.V., EINDHOVEN (NL)

(72) Inventors: SILVIA MARIA BOOIJ, EINDHOVEN (NL); JORIS JAN VREHEN, WAALRE (NL); PETER JOHANNES MARTINUS BUKKEMS, DEURNE (NL)

(21) Appl. No.: 19/488,133

(22) PCT Filed: May 17, 2024
(86) PCT No.: PCT/EP2024/063792

§ 371 Date: Nov. 26, 2025

(30) Foreign Application Priority Data
May 30, 2023 (EP) 23175949.9

(51) Int. Cl. F21V 17/16; F21V 19/00; F21V 23/00

(52) U.S. Cl. CPC F21V 17/164; F21V 19/004; F21V 23/004; F21V 23/007

(57) ABSTRACT

A system (100) is disclosed, comprising a component (10, 20) and a lighting device comprising a housing (30). A surface of the housing (30) comprises at least one first mounting portion (31), and an outer surface of the component (10) comprises at least one second mounting portion (11, 21). The at least one first mounting portion (31) comprises a first plurality of engaging elements (40) monolithically integrated in or on the housing (30) and projecting therefrom, and/or the at least one second mounting portion (11, 21) comprises a second plurality of engaging elements (50) monolithically integrated in or on the component (10), projecting therefrom. By means of the first plurality of engaging elements (40) and/or the at least one second mounting portion (11, 21), the component (10) can be detachably mounted in or on the housing (30).

### TECHNICAL FIELD

The present invention relates to a system comprising a component and a lighting device comprising a housing for accommodating the component.

### BACKGROUND

Lighting devices or luminaires generally include many different components. According to one non-limiting example, the lighting device or luminaire may include one or more light-emitting diodes (LEDs). The components included in a lighting device or luminaire may for example comprise LEDs, driver circuitry (e.g., LED driver circuitry), a diffuser, a reflector, etc. In general, the lighting device or luminaire has a housing in or on which the components may be mounted. Usually, the components are connected to the housing by means of screws. Further, the housing may be closed by means of screws, so as to form an enclosure for the components. In alternative, a threaded construction in the housing may enable a user to close the housing by hand.

US2005/178034A1 discloses a modular display panel formed of a segmented symmetrical graphics panel having display pixels. The panel's interlock to allow forming a larger electronic graphics panel. The preferred shape of the panel is square, defining a perimeter with for edge surfaces. Each of those edge surfaces includes an electrical connection thereon.

KR20170003739U discloses a light-transmitting plate fixing device for a light fixture, in which a fixture is provided with a first pressure plate for press-fitting an upper portion of a light-transmissive plate. As a result, it is possible to improve the productivity of the lighting apparatus by using the fixture to facilitate the coupling of the translucent plate coupled to the case.

U.S. Pat. No. 5,879,604A discloses a mushroom-type hook strip for a hook-and-loop fastener that has a flexible backing of thermoplastic resin and, integral with the backing, an array of upstanding stems distributed across at least one face of the backing, each having a mushroom head. The mushroom-type hook strip can be produced continuously by injecting resin into cavities of a cylindrical mold while evacuating and cooling the cavities so that the cooled resin becomes molecularly oriented, thus providing excellent stiffness, durability, and tensile and flexural strength.

JP3889452B2 discloses a fastener member that includes a base and a plurality of headed projections. The headed projection includes a leg placed upright on the surface of the base and a head formed at the end of the leg. The head includes a bottom surface adjoining to the leg and extending outward from the outer surface of the leg and a top surface arranged on the opposite side to the leg with respect to the bottom surface and extending in a curved form from the outer edge of the bottom surface. The bottom surface of the head comprises a horizontal portion extending from the outer edge to the center while being roughly parallel to the surface of the base and an inclined portion extending diagonally from the inner edge of the horizontal portion toward the apex of the top surface. On the side of the head facing the base, a dent arranged to surround the upper end portion of the leg is formed by the bottom surface.

US2013/000089A discloses a fastening structure which enables objects to be easily coupled to or removed from each other, and which enables the relative positions between the objects to be changed in the longitudinal position of zipper rails. The fastening structure includes a first zipper rail unit which is provided on a planar portion of a first object and has zipper rails arranged parallel to each other, and a second zipper rail unit which is provided on a planar portion of a second object and has zipper rails arranged parallel to each other. While the zipper rails of the first zipper rail unit are individually coupled to the corresponding zipper rails of the second zipper rail unit in a female-male engagement manner, relative positions between the first object and the second object can be changed in the longitudinal direction of the zipper rails.

### SUMMARY

Recyclability and circularity gain more and more attention also for luminaires or lighting devices. To facilitate recyclability and circularity for luminaires or lighting devices, it would be desired to be able to have an easy way of replacing one or more components in the luminaire or lighting device, such as, for example, the LEDs or the driver circuitry (e.g., LED driver circuitry). However, as components of a luminaire or lighting device are usually connected to the housing by means of screws, it may be very difficult to change a component inside a luminaire or lighting device, because there may be holes in the housing (in which the screws were) which are in incorrect positions for the new component which shall replace the old component.

In view of the above, a concern of the present invention is to provide means for facilitating or permitting change of one or more components of a lighting device, with the one or more components being accommodated in or on a housing of the lighting device, with relative ease.

To address at least one of this concern and other concerns, a system in accordance with the independent claim is provided. Preferred embodiments are defined by the dependent claims.

According to a first aspect of the present invention, a system is provided. The system comprises a component (e.g., an electrical component), and a lighting device comprising a housing for accommodating the component. A surface of the housing (e.g., an outer surface of the housing) comprises at least one first mounting portion for mounting of the component in or on the housing. An outer surface of the component comprises at least one second mounting portion for mounting of the component in or on the housing. The at least one first mounting portion is configured to engage with the at least one second mounting portion and/or the at least one second mounting portion is configured to engage with the at least one first mounting portion.

The at least one first mounting portion comprises a first plurality of engaging elements monolithically integrated in the housing, projecting from the housing and configured to engage with the at least one second mounting portion to detachably mount the component in or on the housing. In addition, the at least one second mounting portion comprises a second plurality of engaging elements monolithically integrated in the component, projecting from the component and configured to engage with the at least one first mounting portion to detachably mount the component in or on the housing.

According to a second aspect of the present invention, a component (e.g., an electrical component) of the system according to the first aspect of the present invention is provided, wherein the at least one second mounting portion comprises the second plurality of engaging elements.

According to a third aspect of the present invention, a lighting device of the system according to the first aspect of the present invention is provided, wherein the at least one first mounting portion comprises the first plurality of engaging elements.

In the context of the present application, by an engaging element being monolithically integrated in the housing or the component and projecting from the housing or the component, it is meant that the engaging element is formed so as to form a single unit or piece together with the part of the housing or the component surrounding the engaging element, such that there are no (or substantially no) joints or seams between the engaging element and the part of the housing or the component surrounding the engaging element. Such an engaging element—and a housing or a component comprising a plurality of such engaging elements—may for example be produced by means of injection molding or similar techniques. The engaging elements (e.g., the first plurality of engaging elements and/or the second plurality of engaging elements) may hence be directly (e.g., injection) molded on a surface of at least one of the housing and the component. As a housing and components of a lighting device are often manufactured by (e.g., injection) molding, the provisioning of the first plurality of engaging elements and/or the second plurality of engaging elements may not entail any further costs to the manufacturing process of the housing and the components but may only necessitate a different design or construction of the mold (which may be referred to as the tool).

The first plurality of engaging elements and/or the second plurality of engaging elements may for example be Velcro-like. The first plurality of engaging elements may be configured to engage with the at least one second mounting portion by means of a hook and loop fastening mechanism, with the at least one second mounting portion being configured to mate with the first plurality of engaging elements, to detachably mount the component in or on the housing. Similarly, the second plurality of engaging elements may be configured to engage with the at least one first mounting portion by means of a hook and loop fastening mechanism, with the at least one first mounting portion being configured to mate with the second plurality of engaging elements, to detachably mount the component in or on the housing. However, as described further elsewhere herein, the first plurality of engaging elements and the second plurality of engaging elements may have the same or similar construction, and hence no hook and loop fastening mechanism may be needed.

The first plurality of engaging elements and/or the second plurality of engaging elements may be flexible, so as to provide a flexible fastening interface or mechanism for detachably mounting the component in or on the housing. By such a flexible fastening interface or mechanism, contact sound may be reduced. For example, vibrations of a component in the form of LED driver circuitry may be less noticeable for a user of the lighting device.

By engaging elements monolithically integrated in or on the housing and/or the component and projecting from the housing or the component, respectively, a screwless mounting of the component(s) in or on the housing may be enabled, and no tools may be needed for the mounting of the component(s) in or on the housing, and there may be less or even no need for any holes in the housing. Further, at the end of life of the lighting device, the components of the lighting device may be easily detached from the housing, which facilitates improving recyclability. Further, changing of one or more component of the lighting device (e.g., with new LEDs or new LED driver circuitry) may be carried out with relative ease as compared to if the components would be connected to the housing by means of screws. This is true even if the shape or form of the new component is not the same as the shape or form of the old component which is to be replaced by the new component, which in case the components would be connected to the housing by means of screws would normally require changes in position of the mounting features.

The component may for example comprise an electrical component. For example, the component may comprise one or more LEDs, a substrate (e.g., a printed circuit board) on which one or more LEDs are arranged and/or LED driver circuitry. According to another example, the component may comprise a closure (e.g., a lid) for closing the housing so as to form an enclosure for other components of the lighting device. According to another example, the component may comprise an optical component, such as for example, a lens or a light diffuser.

In particular in cases where a relatively large number of components may be accommodated in or on the housing, the positioning of the components at the correct locations in or on the housing may be facilitated, for example, by having matching colors of a region of the housing where a particular component is to be mounted (e.g., the first mounting portion(s)) and any monolithically integrated engagement elements of the component, or by having a geometrical arrangement or color of any monolithically integrated engagement elements of the component that matches or corresponds to a geometrical arrangement or color of any monolithically integrated engagement elements of the housing.

While the housing is generally described herein as being a housing of a lighting device, the housing could be a housing of another type of device.

According to one or more embodiments of the present invention, the at least one first mounting portion comprises the first plurality of engaging elements and the at least one second mounting portion comprises the second plurality of engaging elements. Thus, monolithically integrated engaging elements as described herein may be provided on both the housing and the component. The first plurality of engaging elements may be configured to engage with the second plurality of engaging elements and/or the second plurality of engaging elements may be configured to engage with the first plurality of engaging elements. However, according to one or more embodiments of the present invention, only one of the housing and the component may be provided with monolithically integrated engaging elements as described herein, while the other one of the housing and the component may be provided with some other means for engaging with the engaging elements, such as, for example, Velcro or some other similar type of fastening mechanism.

For at least some of the engaging elements of the at least one first mounting portion and the at least one second mounting portion, respectively, each engaging element may have a longitudinal axis, and may comprise an elongated portion and a tip portion. The tip portion may be disposed at an end of the elongated portion that is at a distal end of the engaging element. The tip portion may have a proximal end at the said end of the elongated portion and may be arranged such that it at least at the proximal end thereof has a larger cross sectional area in a plane perpendicular to the longitudinal axis as compared to the elongated portion, such that the tip portion at its proximal end has a proximal end surface extending at least partly about the elongated portion and at an angle to the longitudinal axis.

For the at least some of the engaging elements of the at least one first mounting portion and the at least one second mounting portion, respectively, each engaging element may be configured to be of such flexibility so as to permit its proximal end surface—when the engaging element being of the at least one first mounting portion or the at least one second mounting portion is brought into contact with another engaging element being of the other one of the at least one first mounting portion or the at least one second mounting portion—to engage with the proximal end surface of the other engaging element for detachably coupling these engaging elements to each other. Each engaging element may be configured to be of such flexibility so as to permit its proximal end surface—when the engaging element being of the at least one first mounting portion or the at least one second mounting portion is brought into contact with another engaging element being of the other one of the at least one first mounting portion or the at least one second mounting portion—to engage with the proximal end surface of the other engaging element by a snapping action, such that when the engaging element is brought into contact with the other engaging element, the tip portion of the engaging element travels past the tip portion of the other engaging element until the proximal end surface of the engaging element engages with the proximal end surface of the other engaging element by the snapping action.

For at least some of the engaging elements of the at least one first mounting portion and the at least one second mounting portion, respectively, for each engaging element the cross sectional area of the tip portion in the plane perpendicular to the longitudinal axis may vary along the longitudinal axis. For the at least some of the engaging elements of the at least one first mounting portion and the at least one second mounting portion, respectively, for each engaging element the tip portion may be tapered in a direction parallel to the longitudinal axis away from the elongated portion.

At least some of the engaging elements (e.g., of the first plurality of engaging elements and/or the second plurality of engaging elements) may be made from a material selected from one or more thermoplastic elastomers.

At least some of the engaging elements (e.g., of the first plurality of engaging elements and/or the second plurality of engaging elements) may be made from one or more materials having a Shore A hardness in a range from 70 to 90.

The surface of the housing may comprise at least one third mounting portion for mounting of the component in or on the housing. The outer surface of the component may comprise at least one fourth mounting portion for mounting of the component in or on the housing of the lighting device. The at least one fourth mounting portion may comprise a locking portion configured to slidingly engage with a receiving portion of the at least one third mounting portion for detachably mounting the component in or on the housing when the locking portion has been brought into engagement with the receiving portion.

The surface of the housing may comprise a plurality of first mounting portions for mounting of the component in or on the housing. The outer surface of the component may comprise a plurality of second mounting portions for mounting of the component in or on the housing of the lighting device. Each of the first mounting portions may be configured to engage with a respective one of the second mounting portions and/or each of the second mounting portions may be configured to engage with a respective one of the first mounting portions. The first mounting portions may be disposed at different portions of the surface of the housing arranged at an angle to each other. The second mounting portions may be disposed at different portions of the outer surface of the component arranged at an angle to each other.

The at least one first mounting portion of the surface of the housing may be disposed on a part of the housing that is pivotably or hingedly coupled to another part of the housing. Such a pivotal or hinged coupling may be achieved by means of any appropriate pivotal or hinged coupling, such as any appropriate pivotal or hinged coupling as known in the art.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the invention will be described below with reference to the accompanying drawings.

FIG. 1 is a schematic view of a system according to an embodiment of the present invention.

FIG. 2 is a close-up view of a portion of the system illustrated in FIG. 1.

Each of FIGS. 3 to 5 is a schematic view of a system according to an embodiment of the present invention.

All the figures are schematic, not necessarily to scale, and generally only show parts which are necessary in order to elucidate embodiments of the present invention, wherein other parts may be omitted or merely suggested.

### DESCRIPTION WITH REFERENCE TO THE DRAWINGS

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise.

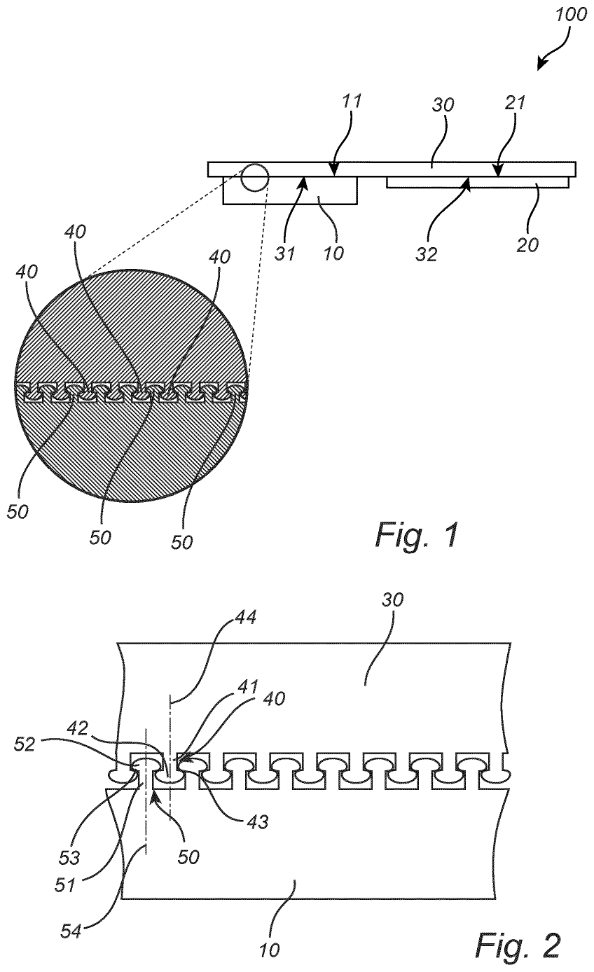

FIG. 1 is a schematic view of a system 100 according to an embodiment of the present invention. The system 100 comprises two components 10, 20 and a lighting device comprising a housing 30 for accommodating the components 10, 20. While two components 10, 20 are depicted in FIG. 1, it is to be understood that the system 100 may in principle comprise any number of components, including a single component. The components 10 and 20 may for example include or be constituted by a substrate (e.g., a printed circuit board) on which one or more light-emitting diodes (LEDs) (not shown in FIG. 1) are arranged, and LED driver circuitry, respectively. The housing 30 may for example comprise a plate, which might be referred to as a base plate (of the lighting device), for accommodating the components 10, 20 thereon. A surface of the housing 30 comprises first mounting portions 31, 32 for mounting of the component on the housing 30. Further, an outer surface of each of the components 10, 20 comprises a second mounting portion 11, 21 for mounting of the respective component 10, 20 on the housing 30. The first mounting portions 31, 32 are configured to engage with the respective ones of the second mounting portions 11, 21, and/or the second mounting portions 11, 21 are configured to engage with the respective ones of the first mounting portions 31, 32.

In accordance with the embodiment of the present invention illustrated in FIG. 1, each of the first mounting portions 31, 32 comprises a first plurality of engaging elements monolithically integrated in or on the housing 30, projecting from the housing 30 and configured to engage with the respective ones of the second mounting portions 11, 21 to detachably mount the components 10, 20 on the housing 30. Further, each of the second mounting portions 11, 21 comprises a second plurality of engaging elements monolithically integrated in or on the respective component 10, 20, projecting from the respective component 10, 20 and configured to engage with the respective ones of the first mounting portions 31, 32 to detachably mount the respective ones of the components 10, 20 on the housing 30. In FIG. 1, only some of the first plurality of engaging elements of the first mounting portion 31 and some of the second plurality of engaging elements of the component 10 are illustrated, and they are depicted in the close-up view in FIG. 1, showing portions of the first mounting portion 31 and the housing 30 and portions of the second mounting portion 11 and the component 10. In the close-up view in FIG. 1, some of the depicted first plurality of engaging elements of the first mounting portion 31 and some of the depicted second plurality of engaging elements of the component 10 are indicated by reference numerals 40 and 50, respectively. Without any loss of generality, any of the first plurality of engaging elements and the second plurality of engaging elements may be referred to as a (first) engaging element 40 and a (second) engaging element 50 in the following.

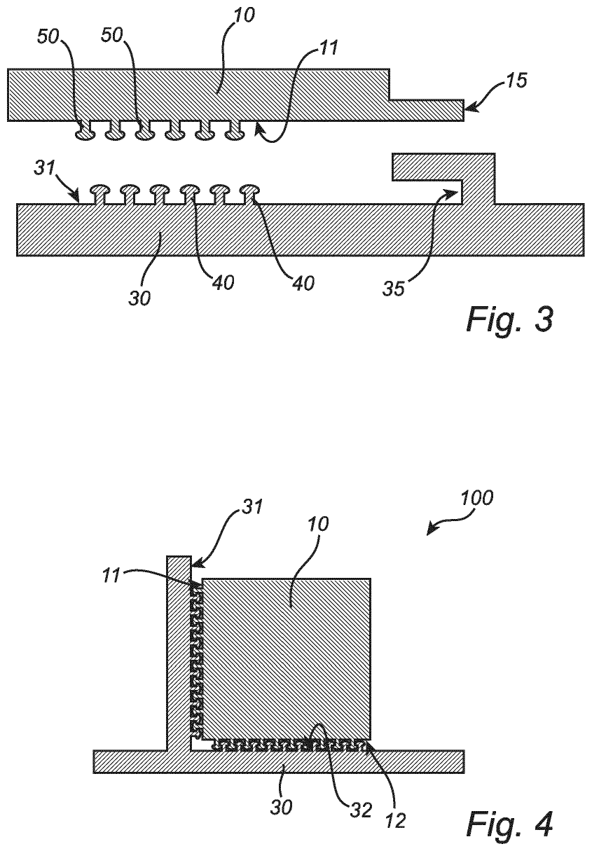

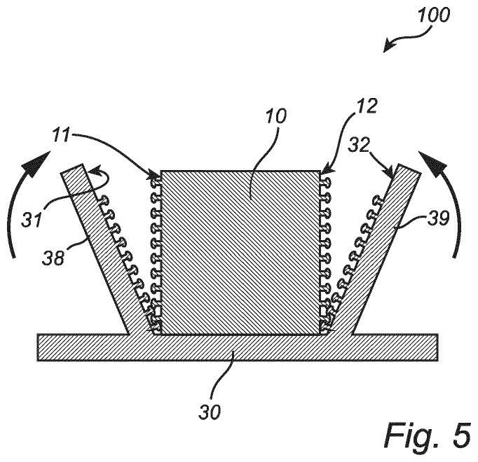

FIG. 2 illustrates the close-up view in FIG. 1 in greater detail.

In accordance with the embodiment of the present invention illustrated in FIGS. 1 and 2, each of the engaging elements 40, 50 may be bulb-shaped, or have a shape similar to a mushroom.

Further in accordance with the embodiment of the present invention illustrated in FIGS. 1 and 2, for each of the depicted engaging elements 40, 50 (only one of the first plurality of engaging elements and one of the second plurality of engaging elements is indicated by reference numerals in FIG. 2), each engaging element 40, 50 has a longitudinal axis 44, 54 and comprises an elongated portion 41, 51 and a tip portion 42, 52. The tip portion 42, 52 is disposed at an end of the elongated portion 41, 51 that is at a distal end of the engaging element 40, 50. The tip portion 42, 52 has a proximal end at the said end of the elongated portion 41, 51 and is arranged such that it at least at the proximal end thereof has a larger cross sectional area in a plane perpendicular to the longitudinal axis 44, 54 as compared to the elongated portion 41, 51 such that the tip portion 42, 52 at its proximal end has a proximal end surface 43, 53 extending at least partly about the elongated portion 41, 51 and at an angle to the longitudinal axis 44, 54. While not shown in FIGS. 1 and 2, each of the first plurality of engaging elements and each of the second plurality of engaging elements included in the system 100 (of which only some may be shown in the figures) may have a configuration such as illustrated in FIGS. 1 and 2 and described in the foregoing.

Each of the engaging elements 40, 50 may be configured to be of such flexibility so as to permit its proximal end surface 43, 53—when the engaging element being of the first mounting portion 31 or of the second mounting portion 11 or 21 is brought into contact with another engaging element 40, 50 being of the other one of the first mounting portion 31 or the second mounting portion 11 or 21—to engage with the proximal end surface 43, 53 of the other engaging element for detachably coupling these engaging elements to each other. For example, in accordance with the embodiment of the present invention illustrated in FIGS. 1 and 2, the engaging element 50 may be configured to be of such flexibility so as to permit its proximal end surface 53, when the engaging element 50 is brought into contact with the engaging element 40, to engage with the proximal end surface 43 of the engaging element 40 for detachably coupling the engaging elements 40 and 50 to each other. Possibly, an engaging element 40 of the first mounting portion 31 may in this way be detachably coupled to several engaging elements 50 of the second mounting portion 11 or 21, or vice versa.

For example, each of the engaging elements 40, 50 may be configured to be of such flexibility so as to permit its proximal end surface 43, 53—when the engaging element being of the first mounting portion 31 or of the second mounting portion 11 or 21 is brought into contact with another engaging element 40, 50 being of the other one of the first mounting portion 31 or the second mounting portion 11 or 21—to engage with the proximal end surface 43, 53 of the other engaging element for detachably coupling these engaging elements to each other by a snapping action. Thereby, when a first engaging element is brought into contact with a second engaging element, the tip portion of the first engaging element may travel past the tip portion of the second engaging element until the proximal end surface of the first engaging element engages with the proximal end surface of the second engaging element by the snapping action. For example, in accordance with the embodiment of the present invention illustrated in FIGS. 1 and 2, the engaging element 50 may be configured to be of such flexibility so as to permit its proximal end surface 53, when the engaging element 50 is brought into contact with the engaging element 40, to engage with the proximal end surface 43 of the engaging element 40 for detachably coupling the engaging elements 40 and 50 to each other by a snapping action, such that when the engaging element 50 is brought into contact with the engaging element 40, the tip portion 42 of the engaging element 40 may travel past the tip portion 52 of the engaging element 52 until the proximal end surface 43 of the engaging element 40 engages with the proximal end surface 53 of the engaging element 50 by the snapping action.

As indicated in FIG. 2, two engaging elements (e.g., engaging elements 40 and 50) may for example be brought into contact with each other by movement of the engaging elements generally towards each other in directions along the longitudinal axes of the respective engaging elements.

The first plurality of engaging elements 40 and/or the second plurality of engaging elements 50 may be arranged in a regular pattern as seen from the above of the surface of the housing 30 or the outer surface of the component 10 or 20, such as, for example, in accordance with a hexagonal pattern. For example, the first plurality of engaging elements 40 and/or the second plurality of engaging elements 50 may be located at the vertices of a hexagonal tiling as seen from the above of the surface of the housing 30 or the outer surface of the component 10 or 20. Such an arrangement of the first plurality of engaging elements 40 and the second plurality of engaging elements 50 may facilitate engagement of the proximal end surface 43, 53 of the engaging elements 40 and 50. For example, it may facilitate the engaging elements 40 and 50 gripping each other.

A sufficient flexibility of the engaging elements 40 and 50 may be achieved by making them from a material selected from one or more thermoplastic elastomers. Most if not all thermoplastic elastomers are injection moldable, and are suitable to use to make the monolithically integrated engaging elements as described herein. Examples of thermoplastic elastomer materials which may be used, alone or in combination, are thermoplastic urethanes and thermoplastic olefins. For example, the entire housing 30 might be made of thermoplastic urethanes. Using thermoplastic elastomer materials, a relatively high stiffness of the housing while also having a flexibility of a rubber may be achieved. The hardeness of thermoplastic elastomer materials may be in a range from 90 Shore D (very hard and almost as plastic) to 60 Shore A (very soft, as car tires). A good balance between stiffness and flexibility may be achieved with a Shore A hardness in a range from 70 to 90. Thus, the engaging elements 40 and 50 may be made from one or more materials (for example one or more thermoplastic elastomers) having a Shore A hardness in a range from 70 to 90.

FIG. 3 is a schematic view of a system 100 according to an embodiment of the present invention. The same reference numerals in FIG. 3 and in FIGS. 1 and 2 denote the same or similar elements, having the same or similar function. In the system 100 illustrated in FIG. 3, the surface of the housing 30 further comprises a third mounting portion 35 for mounting of the component 10 in or on the housing 30. Further, the outer surface of the component 10 further comprises a fourth mounting portion 15 for mounting of the component 10 in or on the housing 30 of the lighting device. The fourth mounting portion 15 comprises a locking portion which is configured to slidingly engage with a receiving portion of the third mounting portion 35 for detachably mounting the component 10 in or on the housing 30 when the locking portion has been brought into engagement with the receiving portion. Thus, according to the embodiment of the present invention illustrated in FIG. 3, the third mounting portion 35 is in addition to the first mounting portion 31 of the housing 30, and the fourth mounting portion 15 is in addition to the second mounting portion 11 of the component 10. As for the system 100 illustrated in FIG. 1, in the system 100 illustrated in FIG. 3, the housing 30 may for example comprise a plate, which may be referred to as a base plate (of the lighting device), for accommodating the component 10 thereon. In accordance with the embodiment of the present invention illustrated in FIG. 3, the third mounting portion 35 is configured to at least in part form a bracket, with the fourth mounting portion 15 being configured so that the component 10 can be slid under the bracket. After the component 10 has been slid under the bracket, the first mounting portion 31 can be engaged with the second mounting portion 11 by pushing down the component 10 on the housing 30, thereby detachably mounting the component 10 on the housing 30.

FIG. 4 is a schematic view of a system 100 according to an embodiment of the present invention. The same reference numerals in FIG. 4 and in FIGS. 1 and 2 denote the same or similar elements, having the same or similar function. In the system 100 illustrated in FIG. 4, the surface of the housing 30 comprises several first mounting portions 31, 32 for mounting of the component 10 in or on the housing 30, and the outer surface of the component 10 comprises several second mounting portions 11, 12 for mounting of the component 10 in or on the housing 30 of the lighting device. The first mounting portion 31 is configured to engage with the second mounting portion 11 (or vice versa), and the first mounting portion 32 is configured to engage with the second mounting portion 12 (or vice versa). It is to be understood that each of the housing 30 and the component 10 might comprise more than two mounting portions, such as three or more mounting portions. In general, each of the first mounting portions may be configured to engage with a respective one of the second mounting portions and/or each of the second mounting portions may be configured to engage with a respective one of the first mounting portions. As illustrated in FIG. 4, the first mounting portions 31, 32 are disposed at different portions of the surface of the housing 30 arranged at an angle to each other, and the second mounting portions 11, 12 are disposed at different portions of the outer surface of the component 10 arranged at an angle to each other. According to the embodiment of the present invention illustrated in FIG. 4, the angle between the first mounting portions 31, 32 and between the second mounting portions 11, 12 is 90 degrees. However, the angle between the first mounting portions 31, 32 and/or between the second mounting portions 11, 12 may differ from 90 degrees. By a configuration as illustrated in FIG. 4, with several first mounting portions and several second mounting portions, the ‘adhesive’ strength between the component 10 and the housing 30 when the component is detachably mounted in or on the housing 30 may become relatively high.

FIG. 5 is a schematic view of a system 100 according to an embodiment of the present invention. The same reference numerals in FIG. 5 and in FIG. 4 denote the same or similar elements, having the same or similar function. According to the embodiment of the present invention illustrated in FIG. 5, each of the first mounting portions 31, 32 of the surface of the housing 30 is disposed on a part 38, 39 of the housing 30 that is pivotably or hingedly coupled to another part of the housing 30. The parts 38, 39 may together with the other part of the housing 30 form a U-shape when the system 100 is viewed from the side, as illustrated in FIG. 5. By moving the parts 38, 39 towards the component 10 as indicated by the arrows in FIG. 5, the first mounting portion 31 can be pushed onto the second mounting portion 11 and the first mounting portion 32 can be pushed onto the second mounting portion 12, respectively, thereby detachably mounting the component 10 on the housing 30.

It is to be noted that in accordance with the respective embodiments of the present invention illustrated in FIGS. 3 to 5, each of the depicted mounting portions include monolithically integrated engagement elements as described herein; however, they are not indicated by any reference numerals in any of FIGS. 3 to 5.

In conclusion, a system is disclosed, comprising a component and a lighting device comprising a housing. A surface of the housing comprises at least one first mounting portion, and an outer surface of the component comprises at least one second mounting portion. The at least one first mounting portion comprises a first plurality of engaging elements monolithically integrated in or on the housing and projecting therefrom, and/or the at least one second mounting portion comprises a second plurality of engaging elements monolithically integrated in or on the component, projecting therefrom. By means of the first plurality of engaging elements and/or the at least one second mounting portion, the component can be detachably mounted in or on the housing.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A system comprising:
a component; and
a lighting device comprising a housing for accommodating the component;
wherein a surface of the housing comprises at least one first mounting portion for mounting of the component in or on the housing, and wherein an outer surface of the component comprises at least one second mounting portion for mounting of the component in or on the housing, wherein the at least one first mounting portion is configured to engage with the at least one second mounting portion and/or the at least one second mounting portion is configured to engage with the at least one first mounting portion;
wherein:
the at least one first mounting portion comprises a first plurality of engaging elements monolithically integrated in the housing, projecting from the housing and configured to engage with the at least one second mounting portion to detachably mount the component in or on the housing;
the at least one second mounting portion comprises a second plurality of engaging elements monolithically integrated in the component, projecting from the component and configured to engage with the at least one first mounting portion to detachably mount the component in or on the housing;
the at least one first mounting portion comprises the first plurality of engaging elements, and the at least one second mounting portion comprises the second plurality of engaging elements, wherein the first plurality of engaging elements are configured to engage with the second plurality of engaging elements and/or the second plurality of engaging elements are configured to engage with the first plurality of engaging elements; and
each engaging element is configured to be of such flexibility so as to permit its proximal end surface—when the engaging element being of the at least one first mounting portion or the at least one second mounting portion is brought into contact with another engaging element being of the other one of the at least one first mounting portion of the at least one second mounting portion—to engage with the proximal end surface of the other engaging element by a snapping action, such that when the engaging element is brought into contact with the other engaging element, the tip portion of the engaging element travels past the tip portion of the other engaging element until the proximal end surface of the engaging element engages with the proximal end surface of the other engaging element by the snapping action.

2. (canceled)

3. The system according to claim 1, wherein for at least some of the engaging elements of the at least one first mounting portion and the at least one second mounting portion, respectively, each engaging element has a longitudinal axis and comprises an elongated portion and a tip portion, wherein the tip portion is disposed at an end of the elongated portion that is at a distal end of the engaging element, and wherein the tip portion has a proximal end at the said end of the elongated portion and is arranged such that it at least at the proximal end thereof has a larger cross sectional area in a plane perpendicular to the longitudinal axis as compared to the elongated portion such that the tip portion at its proximal end has a proximal end surface extending at least partly about the elongated portion and at an angle to the longitudinal axis.

4. The system according to claim 3, wherein for the at least some of the engaging elements of the at least one first mounting portion and the at least one second mounting portion, respectively, each engaging element is configured to be of such flexibility so as to permit its proximal end surface—when the engaging element being of the at least one first mounting portion or the at least one second mounting portion is brought into contact with another engaging element being of the other one of the at least one first mounting portion or the at least one second mounting portion—to engage with the proximal end surface of the other engaging element for detachably coupling these engaging elements to each other.

5. The system according to claim 4, wherein the first plurality of engaging elements and/or the second plurality of engaging elements are flexible so as to provide a flexible fastening interface for detachably mounting the component in or on the housing.

6. A system according to claim 3, wherein for the at least some of the engaging elements of the at least one first mounting portion and the at least one second mounting portion, respectively, for each engaging element the cross sectional area of the tip portion in the plane perpendicular to the longitudinal axis varies along the longitudinal axis.

7. The system according to claim 3, wherein for the at least some of the engaging elements of the at least one first mounting portion and the at least one second mounting portion, respectively, for each engaging element the tip portion is tapered in a direction parallel to the longitudinal axis away from the elongated portion.

8. The system according to claim 1, wherein at least some of the engaging elements are made from a material selected from one or more thermoplastic elastomers.

9. The system according to claim 1, wherein at least some of the engaging elements are made from one or more materials having a Shore A hardness in a range from 70 to 90.

10. The system according to claim 1, wherein the surface of the housing further comprises at least one third mounting portion for mounting of the component in or on the housing, and wherein the outer surface of the component further comprises at least one fourth mounting portion for mounting of the component in or on the housing of the lighting device, wherein the at least one fourth mounting portion comprises a locking portion configured to slidingly engage with a receiving portion of the at least one third mounting portion for detachably mounting the component in or on the housing when the locking portion has been brought into engagement with the receiving portion.

11. The system according to claim 1, wherein the surface of the housing comprises a plurality of first mounting portions for mounting of the component in or on the housing, and the outer surface of the component comprises a plurality of second mounting portions for mounting of the component in or on the housing of the lighting device, wherein each of the first mounting portions is configured to engage with a respective one of the second mounting portions and/or each of the second mounting portions is configured to engage with a respective one of the first mounting portions.

12. The system according to claim 11, wherein the first mounting portions are disposed at different portions of the surface of the housing arranged at an angle to each other, and wherein the second mounting portions are disposed at different portions of the outer surface of the component arranged at an angle to each other.

13. The system according to claim 1, wherein the at least one first mounting portion of the surface of the housing is disposed on a part of the housing that is pivotably or hingedly coupled to another part of the housing.

14. A component of a system according to claim 1, wherein the at least one second mounting portion comprises the second plurality of engaging elements.

15. A lighting device of a system according to claim 1, wherein the at least one first mounting portion comprises the first plurality of engaging elements.

16. The system according to claim 1, wherein the component comprises one or more of an electrical component and an optical component.
